(19) United States
(12) Patent Application Publication
(10) Pub. No.: US 2026/0208781 A1
(43) Pub. Date: Jul. 23, 2026

(54) CLEANROOM CARTS AND METHODS OF USING THE SAME

(71) Applicants: Calvin Ting, Seattle, WA (US); Cameron Shaheen, Wilmington, MA (US)

(72) Inventors: Calvin Ting, Seattle, WA (US); Cameron Shaheen, Wilmington, MA (US)

(21) Appl. No.: 19/130,413

(22) PCT Filed: Nov. 15, 2023
(86) PCT No.: PCT/US2023/079828

§ 371 Date: May 15, 2025

(51) Int. Cl. B62B 3/04; B62B 5/00; B62B 5/06

(52) U.S. Cl. CPC B62B 3/04; B62B 5/0013; B62B 5/06; B62B 2202/56

(57) ABSTRACT

Cleanroom carts and methods of using the same. In at least one embodiment of a cleanroom cart of the present disclosure, the cleanroom cart comprises a cart body comprising a vertical portion and a base portion, a sloped platform coupled to the vertical portion, said sloped platform sloped downward toward a relative front of the cart, a sloped upper surface at a relative top of the cart body, the sloped upper surface sloped downward toward a relative back of the cart, and a plurality of wheels coupled to the base portion.

### PRIORITY

The present application is related to, and claims the priority benefit of, U.S. provisional patent application Ser. No. 63/426,464, filed Nov. 18, 2022, the contents of which are incorporated herein directly and by reference in their entirety.

### BRIEF SUMMARY

The present disclosure includes disclosure of a cleanroom cart, as shown and/or described herein.

The present disclosure includes disclosure of a cleanroom cart, comprising a cart body comprising a vertical portion and a base portion, a sloped platform, said sloped platform sloped downward toward a relative front of the cart, a sloped upper surface at a relative top of the cart body, the sloped upper surface sloped downward toward a relative back of the cart, and a plurality of wheels coupled to the base portion using wheel casters.

The present disclosure includes disclosure of a cleanroom cart, comprising stainless steel.

The present disclosure includes disclosure of a cleanroom cart, wherein the base portion is also sloped downward toward the relative front of the cart.

The present disclosure includes disclosure of a cleanroom cart, further comprising a screen integrated into the vertical portion of the cart body.

The present disclosure includes disclosure of a cleanroom cart, powered by one or more rechargeable batteries positioned within the cart body.

The present disclosure includes disclosure of a cleanroom cart, further comprising a computer positioned within the cart body.

The present disclosure includes disclosure of a cleanroom cart, comprising a cart body comprising a vertical portion and a base portion, a sloped platform coupled to the vertical portion, said sloped platform sloped downward toward a relative front of the cart, a sloped upper surface at a relative top of the cart body, the sloped upper surface sloped downward toward a relative back of the cart, and a plurality of wheels coupled to the base portion.

The present disclosure includes disclosure of a cleanroom cart, wherein the cart body comprises stainless steel.

The present disclosure includes disclosure of a cleanroom cart, wherein the base portion is also sloped downward toward the relative front of the cart.

The present disclosure includes disclosure of a cleanroom cart, further comprising a screen integrated into the vertical portion of the cart body.

The present disclosure includes disclosure of a cleanroom cart, wherein the screen is covered with safety glass.

The present disclosure includes disclosure of a cleanroom cart, powered by one or more rechargeable batteries positioned within the cart body.

The present disclosure includes disclosure of a cleanroom cart, further comprising a computer positioned within the cart body.

The present disclosure includes disclosure of a cleanroom cart, wherein the plurality of wheels each use wheel casters.

The present disclosure includes disclosure of a cleanroom cart, having generally rounded edges and corners.

The present disclosure includes disclosure of a cleanroom cart, further comprising a handle integrated into the sloped platform.

The present disclosure includes disclosure of a cleanroom cart, further comprising one or more ports or peripherals integrated therein.

The present disclosure includes disclosure of a cleanroom cart, further comprising a cord holder coupled to the cart body.

The present disclosure includes disclosure of a cleanroom cart, further comprising a holder for a barcode scanner.

The present disclosure includes disclosure of a cleanroom cart, forming a system, the system further comprising the barcode scanner.

The present disclosure includes disclosure of a cleanroom cart, further comprising a holder for a printer.

The present disclosure includes disclosure of a cleanroom cart, forming a system, the system further comprising the printer.

The present disclosure includes disclosure of a cleanroom cart, comprising a cart body comprising a vertical portion and a base portion, the base portion sloped downward toward a relative front of the cart, a sloped platform coupled to the vertical portion, said sloped platform sloped downward toward the relative front of the cart, a sloped upper surface at a relative top of the cart body, the sloped upper surface sloped downward toward a relative back of the cart, a plurality of wheels coupled to the base portion, and a screen integrated into the vertical portion of the cart body, wherein the cart is powered by one or more rechargeable batteries positioned within the cart body.

The present disclosure includes disclosure of a cleanroom cart, further comprising a computer positioned within the cart body, wherein the computer is powered by the one or more rechargeable batteries, and wherein the cart body comprises stainless steel.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIG. 1 shows a perspective view of a cleanroom cart according to an exemplary embodiment of the present disclosure; and

FIG. 2 shows a block diagram of a cleanroom cart having various components therein, according to an exemplary embodiment of the present disclosure.

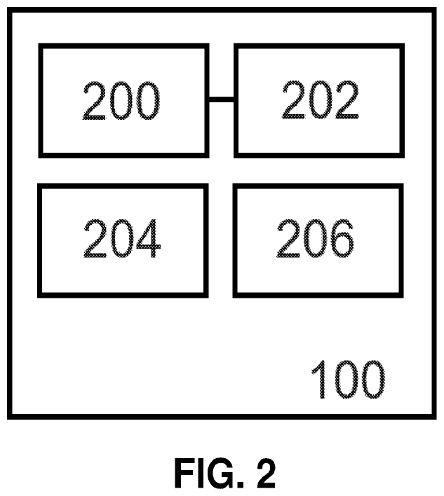

As such, an overview of the features, functions and/or configurations of the components depicted in the various figures will now be presented. It should be appreciated that not all of the features of the components of the figures are necessarily described and some of these non-discussed features (as well as discussed features) are inherent from the figures themselves. Other non-discussed features may be inherent in component geometry and/or configuration. Furthermore, wherever feasible and convenient, like reference numerals are used in the figures and the description to refer to the same or like parts or steps. The figures are in a simplified form and not to precise scale.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

The present disclosure includes disclosure of battery-powered mobile workstations configured for use in a cleanroom, such as within a Class 1 cleanroom environment.

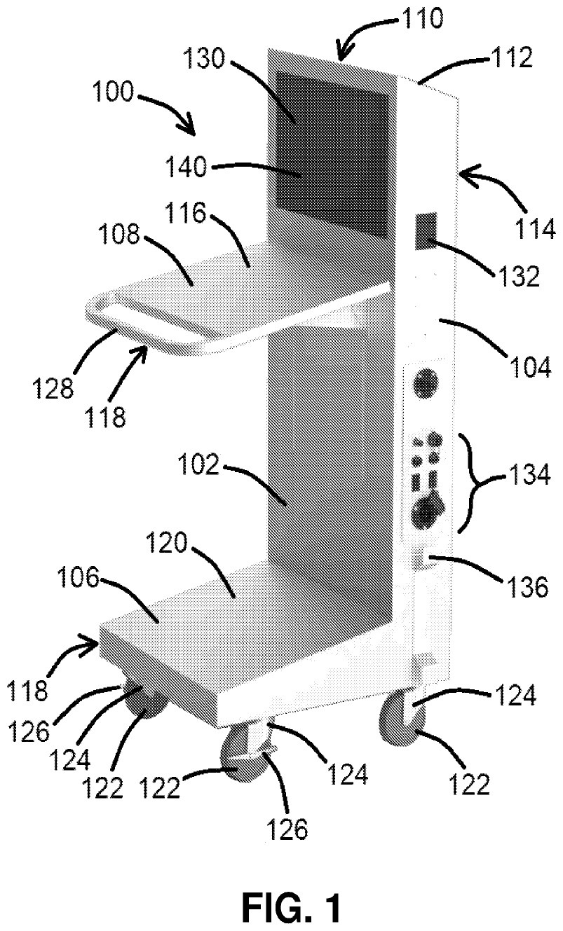

An exemplary cleanroom cart of the present disclosure is shown in FIG. 1. As shown in FIG. 1, cleanroom cart 100 comprises a cart body 102 comprising a vertical portion 104, a base portion 106, and a platform 108. Cart bodies 102, in various embodiments, comprise stainless steel, such as 304 Stainless Steel, and have generally rounded edges and corners to facilitate easy cleaning. Said carts 100 can be used safely within a Class 1 cleanroom environment.

A relative top 110 of exemplary cleanroom carts 100 of the present disclosure comprise a sloped upper surface 112 that slopes down toward a relative back 114 of said carts 100. Platform 108, as shown in FIG. 1, is also mounted so that it has a sloped platform surface 116 that slopes downward toward a relative front 118 of said cart 100. Base portion 106, such as shown in FIG. 1, comprises a sloped base surface 120 that also slopes downward toward a relative front 118 of said cart. Sloped upper surface 112, sloped platform surface 116, and sloped base surface 120 are designed and configured to prevent or minimize dust buildup, as dust would generally slide down each sloped surface in directions away from said cart 100.

Carts 100 of the present disclosure are also mobile by way of wheels 122 and casters 124, whereby casters can also comprise stainless steel (such as polished 304 Stainless Steel) that are easy to clean. Casters 124 can also have wheel locks 126 configured to lock and unlock wheels 122 so to mobilize said cart 100 or keep it in place.

Platform 108, and therefore cart 100, can be engaged by gripping handle 128, as may be desired. Any number of items can be positioned upon platform 108, such as laptops, tablets, smartphones, notebooks, pens, pencils, etc., and should a user of cart 100 need or want to visualize something on the cart itself, a screen 130 can be used to display said information.

Carts 100 of the present disclosure can be powered by way of one or more rechargeable batteries 200, as shown in FIG. 1, positioned within the cart body 102. Said batteries 200 can be used to power the screen 130 and optionally a computer 202 positioned within the cart body.

In various cart 100 embodiments of the present disclosure, an interior compartment is sealed to prevent contamination to the cleanroom environment. As such, there would be no fans or other ports configured to direct air out of the cart 100 into a cleanroom.

Cart 100 embodiments of the present disclosure can also utilize safety glass 140 in connection with covering screen 130 and other displays or gauges 132, such as a battery gauge or display 132. Cart 100 embodiments can further comprise a number of ports or peripherals 134, including, but not limited to, various types of USB ports, HDMI ports, power ports, and other electric and/or electronic ports or peripherals configured to receive cables therein. Ports or peripherals 134 are also waterproof and dustproof to provide additional sealing protection between the inside and the outside of the cart 100. A cord holder 136 can also be coupled to an exemplary cart 100 of the present disclosure so to receive a cord or cable thereon.

The present disclosure includes disclosure of a cleanroom cart, as shown and/or described herein.

The present disclosure includes disclosure of a cleanroom cart, comprising a cart body comprising a vertical portion and a base portion, a sloped platform, said sloped platform sloped downward toward a relative front of the cart, a sloped upper surface at a relative top of the cart body, the sloped upper surface sloped downward toward a relative back of the cart, and a plurality of wheels coupled to the base portion using wheel casters.

The present disclosure includes disclosure of a cleanroom cart, comprising stainless steel.

The present disclosure includes disclosure of a cleanroom cart, wherein the base portion is also sloped downward toward the relative front of the cart.

The present disclosure includes disclosure of a cleanroom cart, further comprising a screen integrated into the vertical portion of the cart body.

The present disclosure includes disclosure of a cleanroom cart, powered by one or more rechargeable batteries positioned within the cart body.

The present disclosure includes disclosure of a cleanroom cart, further comprising a computer positioned within the cart body.

The present disclosure includes disclosure of a cleanroom cart, comprising a cart body comprising a vertical portion and a base portion, a sloped platform coupled to the vertical portion, said sloped platform sloped downward toward a relative front of the cart, a sloped upper surface at a relative top of the cart body, the sloped upper surface sloped downward toward a relative back of the cart, and a plurality of wheels coupled to the base portion.

The present disclosure includes disclosure of a cleanroom cart, wherein the cart body comprises stainless steel.

The present disclosure includes disclosure of a cleanroom cart, wherein the base portion is also sloped downward toward the relative front of the cart.

The present disclosure includes disclosure of a cleanroom cart, further comprising a screen integrated into the vertical portion of the cart body.

The present disclosure includes disclosure of a cleanroom cart, wherein the screen is covered with safety glass.

The present disclosure includes disclosure of a cleanroom cart, powered by one or more rechargeable batteries positioned within the cart body.

The present disclosure includes disclosure of a cleanroom cart, further comprising a computer positioned within the cart body.

The present disclosure includes disclosure of a cleanroom cart, wherein the plurality of wheels each use wheel casters.

The present disclosure includes disclosure of a cleanroom cart, having generally rounded edges and corners.

The present disclosure includes disclosure of a cleanroom cart, further comprising a handle integrated into the sloped platform.

The present disclosure includes disclosure of a cleanroom cart, further comprising one or more ports or peripherals integrated therein.

The present disclosure includes disclosure of a cleanroom cart, further comprising a cord holder coupled to the cart body.

The present disclosure includes disclosure of a cleanroom cart, further comprising a holder for a barcode scanner.

The present disclosure includes disclosure of a cleanroom cart, forming a system, the system further comprising the barcode scanner.

The present disclosure includes disclosure of a cleanroom cart, further comprising a holder for a printer.

The present disclosure includes disclosure of a cleanroom cart, forming a system, the system further comprising the printer.

The present disclosure includes disclosure of a cleanroom cart, comprising a cart body comprising a vertical portion and a base portion, the base portion sloped downward toward a relative front of the cart, a sloped platform coupled to the vertical portion, said sloped platform sloped downward toward the relative front of the cart, a sloped upper surface at a relative top of the cart body, the sloped upper surface sloped downward toward a relative back of the cart, a plurality of wheels coupled to the base portion, and a screen integrated into the vertical portion of the cart body, wherein the cart is powered by one or more rechargeable batteries positioned within the cart body.

The present disclosure includes disclosure of a cleanroom cart, further comprising a computer positioned within the cart body, wherein the computer is powered by the one or more rechargeable batteries, and wherein the cart body comprises stainless steel.

While various embodiments of cleanroom carts and methods for using the same have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A cleanroom cart, comprising:
a cart body comprising a vertical portion and a base portion;
a sloped platform coupled to the vertical portion, said sloped platform sloped downward toward a relative front of the cart;
a sloped upper surface at an upper portion of the cart body, the sloped upper surface sloped downward toward a relative back of the cart; and
a plurality of wheels coupled to the base portion.

2. The cleanroom cart of claim 1, wherein the cart body comprises stainless steel.

3. The cleanroom cart of claim 1, wherein the base portion is also sloped downward toward the relative front of the cart.

4. The cleanroom cart of claim 1, further comprising:
a screen.

5. The cleanroom cart of claim wherein the screen is covered with safety glass.

6. The cleanroom cart of claim 1, powered by one or more rechargeable batteries positioned within the cart body.

7. The cleanroom cart of claim 1, further comprising:
a computer positioned within the cart body.

8. The cleanroom cart of claim 1, wherein the plurality of wheels each use wheel casters.

9. The cleanroom cart of claim 1, having generally rounded edges and corners.

10. The cleanroom cart of claim 1, further comprising:
a handle integrated into the sloped platform.

11. The cleanroom cart of claim 1, further comprising:
one or more ports or peripherals integrated therein.

12. The cleanroom cart of claim 1, further comprising:
a cord holder coupled to the cart body.

13. The cleanroom cart of claim 1, further comprising:
a holder for a barcode scanner.

14. The cleanroom cart of claim 13, forming a system, the system further comprising the barcode scanner.

15. The cleanroom cart of claim 1, further comprising:
a holder for a printer.

16. The cleanroom cart of claim 15, forming a system, the system further comprising the printer.

17. A cleanroom cart, comprising:
a cart body comprising a vertical portion and a base portion, the base portion sloped downward toward a relative front of the cart;
a sloped platform coupled to the vertical portion, said sloped platform sloped downward toward the relative front of the cart;
a sloped upper surface at an upper portion of the cart body, the sloped upper surface sloped downward toward a relative back of the cart;
a plurality of wheels coupled to the base portion; and
a screen;
wherein the cart is powered by one or more rechargeable batteries positioned within the cart body.

18. The cleanroom cart of claim 17, further comprising:
a computer positioned within the cart body, wherein the computer is powered by the one or more rechargeable batteries; and
wherein the cart body comprises stainless steel.
